(19) United States
(12) Patent Application Publication
(10) Pub. No.: US 2003/0081777 A1
(43) Pub. Date: May 1, 2003

(54) System, method and recording unit for protected copying of material

(76) Inventors: Robert Brondijk, Opaal (NL); Maurice Maes, Zijpendaal (NL); Mark Hollar, Palo Alto, CA (US)

Correspondence Address: PATENT DEPARTMENT, MACROVISION CORPORATION, 2830 DE LA CRUZ BLVD., SANTA CLARA, CA, 95050, US

(21) Appl. No.: 10/014,636

(22) Filed: Oct. 26, 2001

(51) Int. Cl. H04L 9/00

(52) U.S. Cl. 380/201

(57) ABSTRACT

A system, method and recording unit for protected copying of material is disclosed. The system includes a compliant preprocessing unit that performs copy-once functionality on material before providing it to a recording unit. The recording unit operates with both compliant and non-compliant preprocessing units or other senders of material for protected copying of the material. It includes at least a primary detector to detect copy-never and copy-once indications in the material, but lacks copy-once functionality including remarking capability. If the recording unit detects a copy-once indication in the received material, it tries to establish a secure channel with the sender of the material. If a secure channel is established, information of the copy-once indication is passed back to sender for appropriate action. If the secure channel is not established, the received material is not copied.

### FIELD OF THE INVENTION

The present invention generally relates to the copying of material and in particular, to a system, method and recording unit for protected copying of material.

### BACKGROUND OF THE INVENTION

Content providers are rightfully concerned about illegal or inappropriate copying of copyrightable content. This is particularly problematic with the proliferation of personal computers (“PCs”) with digital versatile or video disc (“DVD”) recordable drives or drives with other forms of high capacity removable and recordable media. To mitigate this concern, there has been some level of agreement between various industries that the computer industry should consider adding copy control technologies at various points in PCs. In particular, the possibility has been discussed of including video watermark detection in DVD drives.

Copy control has at least two distinct functionalities that might be found desirable. The first, and probably most obvious, would be to prevent any copying of copyrightable content onto recordable DVD media. This form of copy control is probably most desirable for video content distributed on packaged media, such as DVD-Video as stored on read-only memory (DVD-ROM), or perhaps pay-per-video video distribution via cable or satellite distribution systems.

In some cases, such as subscription television or television services where individual channels are paid for, there is generally a right, or at least an expectation, that time shifting of program material is allowed. This creates a need for a second type of copy control functionality that allows one copy of program material to be made while preventing additional copies from being made from that copy. This is often referred to as “copy-once” functionality. In a copy-once capable system, video content or material must first be designated as being copy-once. However, once that first copy has been made, the video from that copy must have a new state, a “no-more-copies” or “copy-no-more” state. It is also possible that copy-once functionality could be used as part of a system for electronic distribution of video content in lieu of packaged media.

Copy-once functionality provides a number of complications to a watermarking based copy control system. Providing the ability to transition content from the “copy-once” state to the “copy-no-more” state may add cost to either the core watermark detection circuitry or to devices implementing the watermarking as part of a system. In some cases, PC hardware manufacturers may not want to support the copy-once functionality, but with some system designs may have limited options to acquire components that do not include its cost.

### OBJECTS AND SUMMARY OF THE INVENTION

Accordingly, it is an object of the present invention to provide a system, method and recording unit for providing protected copying of material that minimize the component cost of such protection.

Another object is to provide a system, method and recording unit for providing protected copying of material that minimize the cost to consumers that do not desire or need copy-once functionality.

Still another object is to provide a system, method and recording unit for providing protected copying of material that provides correct results even when interacting with non-compliant devices.

Yet another object is to provide a system, method and recording unit for providing protected copying of material that provides correct results even in the event of certain detector failures.

These and additional objects are accomplished by the various aspects of the present invention, wherein briefly stated, one aspect is a system for providing protected copying of material, comprising: a preprocessing unit having an output and capable of providing copy-once functionality on a material before providing the material on the output; and a recording unit coupled to the preprocessing unit output, and capable of searching for a copy-never indication in the material provided on the preprocessing unit output and copying the material unless the copy-never indication is found, but lacking capability to remark the material with a copy-no-more indication.

Another aspect is a method implemented in a recording unit for providing protected copying of material, comprising: detecting if a copy-never or copy-once indication is provided with a material; if the copy-never indication is detected, then not allowing copying of the material; if neither the copy-never nor the copy-once indication is detected, then allowing copying of the material; and if the copy-once indication is detected, then transmitting information of its detection back to a sender of the material provided a secure channel is established with the sender, otherwise not allowing copying of the material.

Another aspect is a recording unit for providing protected copying of material. The recording unit includes an input channel, primary detector and compliance logic. The input channel receives a material for copying. The primary detector detects if a copy-never indication and a copy-once indication are provided with the material. The compliance logic is configured such that if the copy-never indication is detected, then it prevents the material from being copied; if neither the copy-never nor the copy-once indication is detected, then it allows the material to be copied.

Still another aspect is another system for providing protected copying of material. The system includes a preprocessing unit and a recording unit coupled to the preprocessing unit.

The preprocessing unit has at least one input channel for receiving material and an output channel for providing an output. The material is provided as the preprocessing unit's output if neither a copy-never indication nor a copy-once indication is detected as being provided with the material. The material is not provided as the preprocessing unit's output if either the copy-never indication is detected as being provided or the copy-once indication and a copy-no-more indication are both detected as being provided with the material. An encrypted version of the material including the copy-no-more indication is provided as the pre-processing unit's output and the output channel is configured to be a secure channel if the copy-once indication is detected and the copy-no-more indication is not detected prior to the inclusion with the material.

The recording unit includes a primary detector and compliance logic. The primary detector detects if a copy-never indication and a copy-once indication are provided with the preprocessing unit's output. The compliance logic is configured such that if the copy-never indication is detected, then it does not allow the preprocessing unit's output to be recorded, and if neither the copy-never nor the copy-once indication is detected, then it allows the preprocessing unit's output to be copied.

Additional objects, features and advantages of the various aspects of the present invention will become apparent from the following description of its preferred embodiments, which description should be taken in conjunction with the accompanying drawings.

### BRIEF DESCRIPTION OF THE DRAWINGS

FIG. 1 illustrates, as an example, a block diagram of a system implemented in a personal computer for providing protected copying of material, utilizing aspects of the present invention.

FIG. 2 illustrates, as an example, a block diagram of a system implemented in a non-compliant personal computer including a recording unit for providing protected copying of material, utilizing aspects of the present invention.

FIG. 3 illustrates, as an example, a truth table for compliance logic implemented in a preprocessing unit for providing protected copying of material, utilizing aspects of the present invention.

FIG. 4 illustrates, as an example, a truth table for compliance logic implemented in a recording unit for providing protected copying of material, utilizing aspects of the present invention.

FIG. 5 illustrates, as an example, a truth table for alternative compliance logic implemented in a recording unit for providing protected copying of material, utilizing aspects of the present invention.

FIG. 6 illustrates, as an example, a flow chart of a method implemented in a preprocessing unit for providing protected copying of material, utilizing aspects of the present invention.

FIG. 7 illustrates, as an example, a flow chart of a method implemented in a recording unit for providing protected copying of material, utilizing aspects of the present invention.

FIG. 8 illustrates, as an example, a flow chart of an alternative method implemented in a recording unit for providing protected copying of material, utilizing aspects of the present invention.

FIG. 9 illustrates, as an example, a flow chart of a method implemented in a preprocessing unit for providing back-up detection of primary watermark detection, utilizing aspects of the present invention.

FIG. 10 illustrates, as an example, a block diagram of an alternative system implemented in a personal computer for providing protected copying of material, utilizing aspects of the present invention.

FIG. 11 illustrates, as an example, a truth table for compliance logic implemented in a recording unit including both primary and secondary detectors for providing protected copying of material, utilizing aspects of the present invention.

FIG. 12 illustrates, as an example, a truth table for alternative compliance logic implemented in a recording unit including both primary and secondary detectors for providing protected copying of material, utilizing aspects of the present invention.

FIG. 13 illustrates, as an example, a flow chart of a method implemented in a recording unit including both primary and secondary detectors for providing protected copying of material, utilizing aspects of the present invention.

FIG. 14 illustrates, as an example, a flow chart of an alternative method implemented in a recording unit including both primary and secondary detectors for providing protected copying of material, utilizing aspects of the present invention.

### DETAILED DESCRIPTION OF THE PREFERRED EMBODIMENT

As used herein: the terms “audio-visual content” or “A/V content” includes audio, visual and other multimedia content including motion pictures, music, the spoken word, photos, and printed text; “material” and “content” may be used interchangeably, and includes A/V and other distributed content including computer programs or software; and “proprietary material” means material protected by contract or intellectual property law.

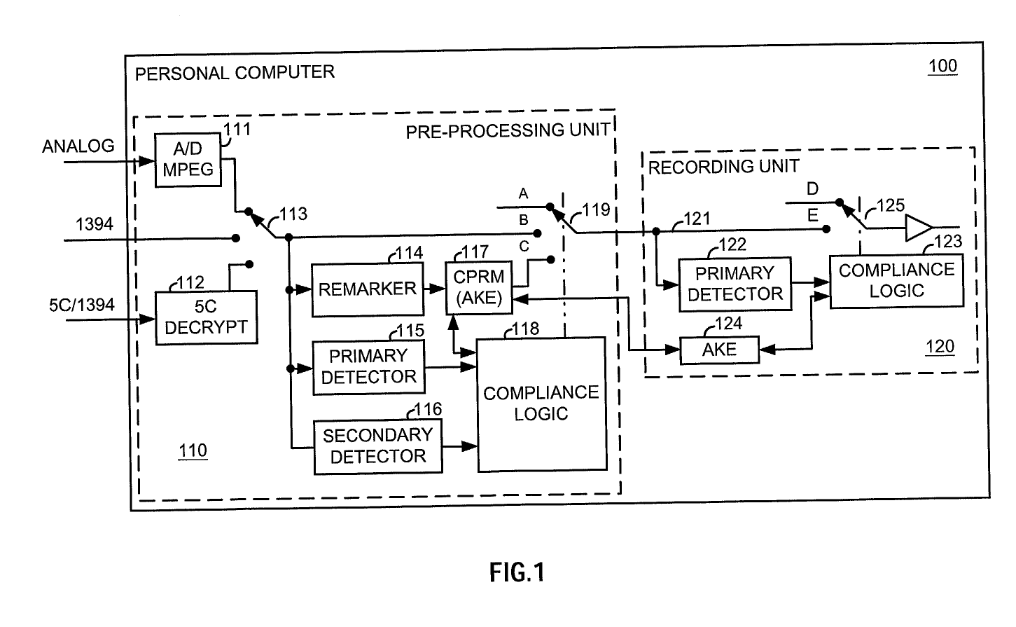

FIG. 1 illustrates, as an example, a block diagram of a system for providing protected copying of material that is implemented in a personal computer 100. The system includes a preprocessing unit 110 and a recording unit 120 that provide protected copying of material in such a manner that minimizes the component cost of such protection, minimizes the cost to consumers that do not desire or need copy-once functionality, provides correct results even when interacting with non-compliant devices, and provides correct results even in the event of certain detector failures. The preprocessing unit 110 is preferably configured on an expansion board to the PC such as a video capture board or a network board such as a Firewire/5C-IEEE-1394 board. The recording unit 120 is preferably a drive installed in or otherwise coupled to the PC that is designed for recording material on recordable media such as, for examples, a DVD recordable drive, CD recordable drive, or flash memory or other solid-state memory recordable unit. Commonly, such recordable media may be both high capacity and removable, but need not necessarily be so to practice the present invention.

A key feature of this system is that it does not include a secondary detector or a remarker in the recording unit 120. In particular, copy-once functionality is performed outside of the recording unit 120 in this system. This has the advantage of reducing the cost of the recording unit 120, which is important since any cost added to the recording unit 120 will have to be borne by all consumers of PC's having such recording units installed, whether they desire to record (i.e., copy) copy-once material or not. For example, if the consumer is only using the PC's recording unit to store PC application data, copy-once functionality provides only limited value to that consumer. A primary detector 122 is included in the recording unit 120, however, since, among other reasons, detection in the recording unit 120 of a copy-never indication in material to be copied has been a strongly stated requirement by content provider companies as a mechanism to prevent inappropriate copying of their material.

In this system, copy-once functionality is performed in the preprocessing unit 110. This “outside-the-recording-unit” configuration is well understood from prior art. For example, the Copy Protection System Architecture (“CPSA”) described by IBM, Intel, Matsushita and Toshiba is one possible architecture utilizing watermarking, analog or digital inputs and encryption on recordable media.

Since the preprocessing unit 110 preferably resides in an optional expansion board installed in the PC, relocating the secondary detector and remarker used for copy-once functionality to the preprocessing unit 110 thus sets up a situation where only consumers that desire the copy-once functionality have to pay for it. In this case, there would be commercially available compliant expansion boards including copy-once functionality, and non-compliant expansion boards that do not include the copy-once functionality. If the only material that a particular consumer ever wanted to capture were not proprietary material, then a standard non-compliant expansion board would be fine for that consumer. Thus, such a consumer is saved from the expense of purchasing the more expensive compliant expansion board with the added copy-once functionality.

As will be discussed in more detail in the following, another key feature of this system is the addition of certain added logic in the preprocessing unit 110 and recording unit 120 that compensates for a failure of the preprocessing unit 110 to properly detect a copy-once indication in received material. In particular, in those situations where the preprocessing unit 110 fails to detect a copy-once indication, but the recording unit 120 does, then the recording unit 120 sends information of such detection back to the preprocessing unit 110 provided a secure channel is established between the preprocessing unit 110 and the recording unit 120.

Such a situation could arise, because of the statistical nature of detectors in the preprocessing unit 110 and the recording unit 120, and in particular, the variability of performance of their primary detectors operating in different domains (e.g., baseband and MPEG) and/or the variability of their detectors resulting from different optimizations for different environments (e.g., in the recording unit 120 versus in the preprocessing unit 110).

The preprocessing unit 110 then treats the received information of the recording unit's detection of the copy-once indication as though the preprocessing unit 110 had itself detected the copy-once indication, thereby compensating for its previous failure to do so. Addition of this feature in the system avoids the unfortunate consequence of otherwise preventing a consumer from making a copy of the material that he or she might otherwise be allowed to make.

Referring back to FIG. 1 now, the preprocessing unit 110 receives an incoming stream of material from one of several possible of its input channels depending upon the format of the incoming stream. For example, if the incoming stream represents analog data, then the preprocessing unit 110 positions its switch 113 to receive the output of analog-to-digital (“A/D”) and MPEG converter 111. On the other hand, if the incoming stream of material is from a 1394 link layer device such as copy-free (“CF”) material from a camcorder, then the preprocessing unit 110 positions its switch 113 to receive that incoming stream. As another example, if the incoming stream of material is from a 1394 link layer device with 5C copy protection, then the preprocessing unit 110 positions its switch 113 to receive the output of 5C decrypter 112.

A primary detector 115 examines or searches the incoming stream of material for either a copy-never (“CN”) indication or a copy-once (“CO”) indication provided with the material. At the same time, a secondary detector 116 examines or searches the incoming stream of material for a copy-no-more (“CNM”) or related secondary indication provided with the material.

Preferably, the copy-never indication comprises a copy-never watermark embedded in the material that indicates that the material should not be copied under any circumstances. The copy-once indication preferably comprises a copy-once watermark embedded in the material that indicates that the material may be copied only once. The copy-no-more indication preferably comprises a copy-no-more watermark embedded in the material that indicates that the material has already been copied once and is to be copied no more. Alternatively, where a related secondary indication is provided with the material instead of a copy-no-more indication, the related secondary indication preferably comprises a secondary watermark that was previously embedded in the material by a remarker such as remarker 114. The copy-no-more indication is deduced in this case by compliance logic 118 after receiving a copy-once watermark detected by the primary detector 115 and the secondary watermark detected by the secondary detector 116.

If the CN watermark is detected or found in the incoming stream of material by the primary detector 115, then information of such detection is passed to compliance logic 118 which causes A-B-C switch 119 to be set to position A so that the incoming stream of material is not passed to the recording unit 120 and therefore, is not recorded or copied. Likewise, if the CO watermark is detected or found in the incoming stream of material by the primary detector 115 and the CNM watermark is detected or found in the incoming stream of material by the secondary detector 116, then information of such detections are passed to the compliance logic 118 which causes the A-B-C switch 119 to again be set to position A so that the incoming stream of material is not passed to the recording unit 120 and therefore, is not recorded or copied. If neither the CN or CO watermarks are detected or found by the primary detector 115, nor the CNM watermark detected or found by the secondary detector 116, then information of such lack of detection is passed to the compliance logic 118 which causes the A-B-C switch 119 to be set to position B so that the incoming stream of “copy-free” (“CF”) material is passed to the recording unit 120 and therefore, is allowed to be freely recorded or copied.

On the other hand, if the CO watermark is detected or found in the incoming stream of material by the primary detector 115 and the CNM watermark is not detected or found by the secondary detector 116, then information of such is passed to the compliance logic 118 which thereupon causes the A-B-C switch 119 to be set to position C. A remarker 114 then remarks the incoming CO watermarked stream of material to include a CNM watermark.

A CPRM unit 117 in the preprocessing unit 110 establishes a CPRM-encrypted/secure channel with an AKE unit 124 in the recording unit 120 through an authentication and key exchange (“AKE”) protocol such as Diffie-Hellman. This secure channel guarantees through the use of secrets known to compliant devices (i.e., the expansion board including the preprocessing unit 110 and the recordable drive including the recording unit 120) that other devices that might intercept the stream of material at an intermediate location are unable to recover the original, unencrypted content. The secure channel can also help maintain a chain of license requirements. For example, the 5C/1394 link layer is also an encrypted/secure channel. Therefore, the source device at the other end of that channel doesn't release content to the PC unless the PC knows the 5C decryption secrets. Likewise, the CPRM unit 117 won't release content to the recording unit 120 unless the AKE unit 124 proves its ability to comply with established rules by successfully completing the AKE process and proving that it knows the correct secrets. After transmission is completed, the secure channel is disabled.

If the recording unit 120 is receiving material from a compliant expansion board, then its primary detector 122 should not detect a CN or CO watermark in received material since the only two types of material that it should be receiving is CF material over the normal, non-secure channel resulting from the switch A-B-C 119 in the preprocessing unit 110 being in the B position, or remarked material over the encrypted/secure channel resulting from the switch A-B-C 119 being in the C position.

Therefore, if the primary detector 122 does detect a CN or CO watermark in received material, then either the expansion board providing the material is (i) a non-compliant expansion board, or (ii) a compliant expansion board whose primary detector has failed for some reason to detect the CN or CO watermark in the material. To determine which situation exists, upon detection of a CN or CO watermark by the primary detector 122, the AKE unit 124 attempts to establish a secure channel with the sender of the material.

If the AKE unit 124 is able to establish the secure channel, then the sender of the received material must have been a compliant expansion board whose primary detector has failed for some reason to detect the CN or CO watermark in the material since only a compliant expansion board would be capable of establishing the secure channel with the AKE unit 124. In this case, instead of the primary detector 122 in the recording unit 120 controlling the switch D-E 125 through compliance logic 123 in the recording unit 120 when it detects a CN or CO watermark in received material, it passes information of such detection back to the primary detector 115 in the preprocessing unit 110 through the secure channel. The primary detector 115 in the preprocessing unit 110 then uses the combination of the information of the recording unit's primary detector 122 and the preprocessing unit's primary detector 115 to make a decision. Based on the decision made, the compliance logic 118 controls the switch A-B-C 119 in the preprocessing unit 110 as appropriate.

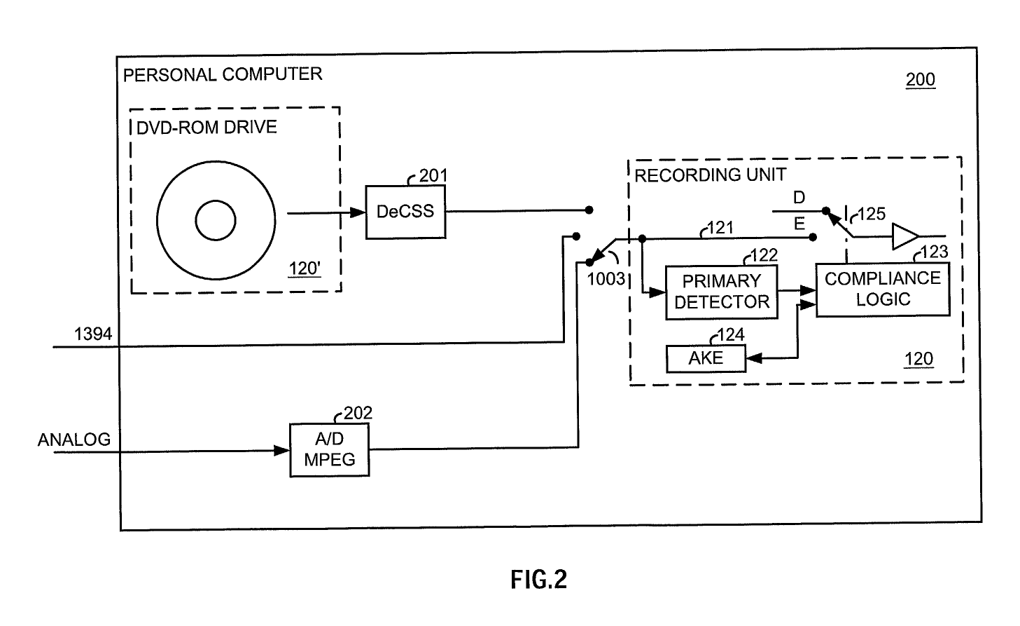

On the other hand, if it is unable to establish the secure channel, then the sender of the received material must have been a non-compliant expansion board that has no capability to detect the CN or CO watermark in the material. An example of this situation is shown in FIG. 2. In this case, the AKE unit 124 knows that a secure channel hasn't been established so the CN or CO watermark detection information is transmitted to the compliance logic 123 in the recording unit 120. The compliance logic 123 then controls switch D-E 125 in the recording unit 120 to allow copying of the received material if no CN or CO watermark is detected, and disallow copying of the received material if either a CN or CO watermark is detected.

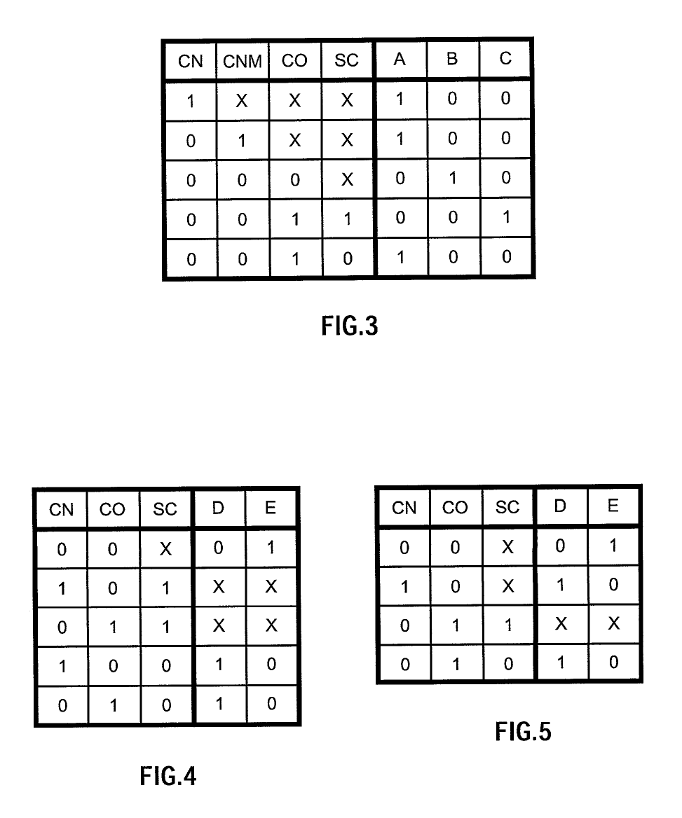

FIG. 3 illustrates, as an example, a truth table for the compliance logic 118 implemented in the preprocessing unit 110. If a CN watermark is detected (indicated by a “1” in the figure), then the CO and CNM watermarks would not be expected to be present in the material. In any event, however, if the CN watermark is detected, then it doesn't matter whether either of the CO or CNM watermark is present or whether a secure channel can be established (indicated by “X's” in the figure). The compliance logic 118 in this situation causes the switch A-B-C 119 to be placed in the A position so that no material is transmitted to the recording unit 120 for copying.

If the CN watermark is not detected (indicated by a “0” in the figure), but the CNM watermark is, then the CO watermark would also be expected to be present in the material. In any event, however, if the CNM watermark is detected, then it doesn't matter whether the CO watermark is present or whether a secure channel can be established. The compliance logic 118 in this situation also causes the switch A-B-C 119 to be placed in the A position so that no material is transmitted to the recording unit 120 for copying.

In the simple case of no watermarks being detected, then the compliance logic 118 in this situation causes the switch A-B-C 119 to be placed in the B position so that the material is freely transmitted to the recording unit 120 for copying.

If neither the CN or CNM watermarks are detected, but the CO watermark is, then the compliance logic 118 causes the CPRM unit 117 to try to establish a secure channel with the recording unit 120. If a secure channel (“SC”) can be established (indicated by a “1” in the figure), then the compliance logic 118 causes the switch A-B-C 119 to be placed in the C position so that the material can be transmitted after being remarked with the CNM watermark by the remarker 114 over the encrypted/secure channel established by the CPRM unit 117 to the recording unit 120 for copying. After the material has been thus transmitted, the encrypted/secure channel is disabled. On the other hand, if the secure channel cannot be established (indicated by a “0” in the figure), then the compliance logic 118 causes the switch A-BC 119 to be placed in the A position so that no material is transmitted to the recording unit 120 for recording or copying.

FIG. 4 illustrates, as an example, a truth table for compliance logic 123 implemented in the recording unit 120. Starting with the simple case where no watermarks are detected, the compliance logic 123 in this situation causes the switch D-E 125 to be placed in the E position so that the material can be recorded or copied. One example where no watermark would be detected is where the incoming stream of material is from a 1394 link layer device such as copy-free (“CF”) material from a camcorder. Another example where no watermark would be detected is where the incoming stream of material is copy-once material that has been processed by a compliant PC through a pre-processing unit such as preprocessing unit 110. In this case, the remarker 114 of the pre-processing unit 110 has remarked the copy-once material with a copy-no-more or related secondary watermark, and the CPRM unit 117 of the pre-processing unit 110 has encrypted the material, thereby making any embedded watermarks undetectable to the primary detector 122 of the recording unit 120. The CPRM unit 117 has also established a secure channel with the recording unit 120 through a conventional AKE process, and transmitted the encrypted material over the secure channel to the recording unit 120. In both of these cases, the recording unit 120 is allowed to record or copy the material.

On the other hand, if either a CN or CO watermark is detected, then the compliance logic 123 causes the AKE unit 124 to try to establish a secure channel with the preprocessing unit 110. If a secure channel (“SC”) is established, then the compliance logic 123 causes information of the CN or CO watermark detection to be passed back to the recording unit 110, and leaves switch D-E 125 alone for the time being. The preprocessing unit 110 then uses that information as though it had detected the same watermark as the recording unit 120. On the other hand, if the secure channel cannot be established, then the compliance logic 123 causes the switch D-E 125 to be placed in the D position so that the material cannot be recorded or copied.

One example where either a CN or CO watermark would be detected is where a compliant PC coupled to the recording unit 120 and including a pre-processing unit such as pre-processing unit 110, has failed to detect the primary watermark for some reason. In this case, a secure channel is established and compliance logic 118 of the pre-processing unit 110 uses the CN or CO watermark information being passed back to it by the recording unit 120 as though its primary detector 115 had detected the watermark. In the case of a CN watermark detection, the compliance logic 118 causes the switch A-B-C 119 to be placed in the A position so that no material is passed to the recording unit 120, and consequently, no material may be copied. In the case of a CO watermark detection, if a copy-no-more or related secondary indication is not detected by the secondary detector 116, then the compliance logic 118 causes the remarker 114 and the CPRM unit 117 to process the material, and causes the switch A-B-C 119 to be placed in the C position so that the encrypted material is passed to the recording unit 120 over the secure channel. After the encrypted material has been thus passed, the secure channel is disabled. In this case, the primary detector 122 of the recording unit does not detect the CO watermark, because of the encryption, and the compliance logic 123 in the recording unit 120 causes the switch D-E 125 to be placed in the E position so that the material is allowed to be recorded or copied.

Another example where either a CN or CO watermark would be detected is where a non-compliant PC such as the personal computer 200 in FIG. 2 has inappropriately passed material to the recording unit 120 for recording or copying, such as, for example, in the case of Content Scrambling System (“CSS”) encrypted material that has inappropriately been descrambled using a DeCSS module such as DeCSS unit 201. In this case, since a secure channel is not established with the non-compliant PC 200, the compliance logic 123 in the recording unit 120 appropriately causes the switch D-E 125 to be placed in the D position so that the descrambled material is not allowed to be recorded or copied.

FIG. 5 illustrates, as an example, a truth table for alternative compliance logic 123′ that may be implemented in the recording unit 120. In this implementation, information of a CN watermark detection is not transmitted back to the preprocessing unit 110. Only information of a CO watermark detection is transmitted back to the preprocessing unit 110. Accordingly, when the CN watermark is detected in this implementation, the compliance logic 123′ causes the switch D-E 125 to be placed in the D position so that the material cannot be recorded or copied. If the CO watermark is detected, however, then the compliance logic 123′ causes the AKE unit 124 to try to establish a secure channel with the preprocessing unit 110. If a secure channel (“SC”) is established, then the compliance logic 123′ causes information of the CO watermark detection to be passed back to the recording unit 110, and leaves switch D-E 125 alone for the time being. The preprocessing unit 110 then uses that information as though it had detected the same watermark as the recording unit 120. On the other hand, if the secure channel is not established, then the compliance logic 123′ causes the switch D-E 125 to be placed in the D position so that the material cannot be recorded or copied.

Although the system including the preprocessing unit 110 and the recording unit 120 is described as being incorporated into a personal computer 100, it is to be appreciated that such a system could also be employed in many other useful configurations. For example, the preprocessing unit 110 may be incorporated into a set-top box with the recording unit 120 integrated into the set-top box or a stand-alone unit coupled to the set-top box. As another example, the preprocessing unit 110 may be incorporated into a network appliance with the recording unit 120 integrated into the network appliance or a stand-alone unit coupled to the network appliance.

Also, it is to be appreciated that while video watermarks are focused on in this and other examples, there is nothing that prevents all that is described herein from applying to audio watermarks as well.

In addition, while the encryption referenced herein is generally labeled as CPRM-encryption, the watermarking technology could be bundled with any number of other encryption technologies that are available. The critical features of the encryption system associated with the watermark remarker are that it: (i) “wraps” the watermarked content such that it isn't discernable by the primary detector 122 in the recording unit 120, and (ii) is capable of performing an authentication and key exchange process in order to establish a secure channel between the preprocessing unit 110 and the recording unit 120. Note that this secure channel is not unlike the secure channel that is established in a CSS-compliant system between a DVD-ROM drive and an associated MPEG decoder board in order to allow playback of DVD-Video discs.

Also, it is to be appreciated that while the notion of a PC expansion board is generally used in this description to identify the location of the preprocessing unit's remarker 114, CPRM-encryption unit 117, and primary and secondary detectors, 115 and 116, it very well could be that these functions are performed in PC software or a hybrid software/hardware set. In the case of software or hybrid software/hardware, there may be additional requirements to add tamper-resistance, tamper-proofing or tamper-detection in actual implementations. Additionally, although switches are described for controlling the passing of material through and from the preprocessing unit 110 and recording unit 120, in practice, such switching functions may be implemented in software, hardware or a combination of the two. Also, as is well known, logic such as compliance logic 118 and 123 may also be implemented in various ways including a processor, a state machine, stand-alone logic or circuits, or a combination of these and/or other conventionally known items.

Further, although the recording units and various methods for providing protect material are described herein as attempting to establish a secure channel with a sender of material after detection of a CO watermark in that material, it may be useful in certain applications to pre-establish the secure channel with the sender prior to such detection. Accordingly, the scope of the present invention is generally not to be limited by the order in which watermark detection and secure channel establishment are performed.

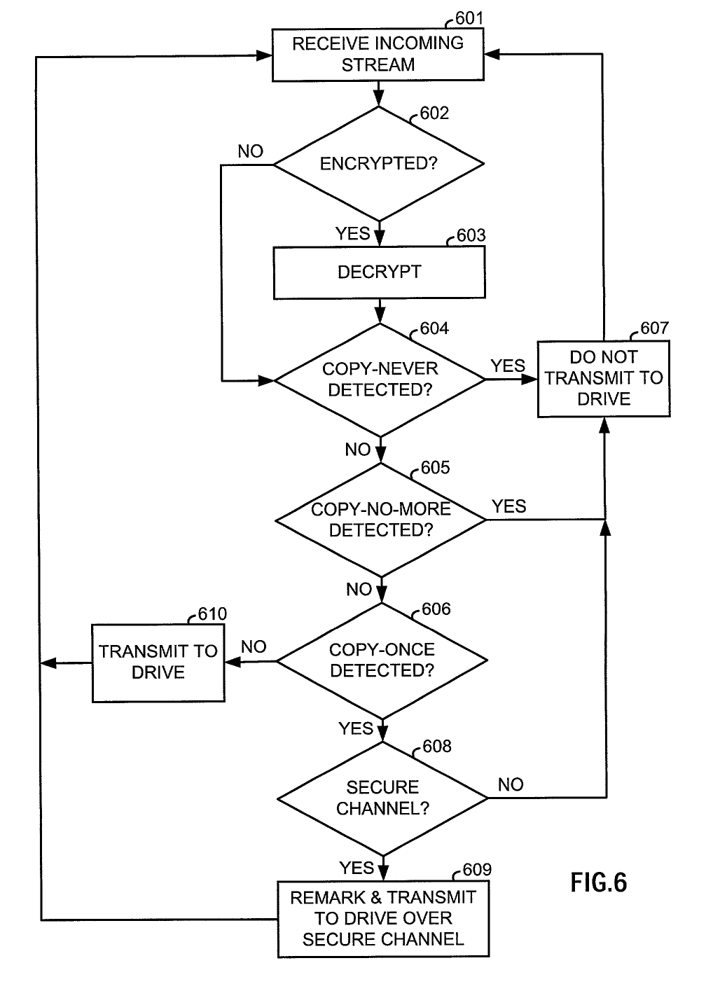

FIG. 6 illustrates, as an example, a flow chart of a method implemented in the preprocessing unit 110 for providing protected copying of material. In 601, the preprocessing unit 110 receives an incoming stream of material. In 602, the preprocessing unit 110 determines whether the material is encrypted. If it is, then in 603, it decrypts the material. In 604, 605 and 606, the preprocessing unit 110 respectively detects whether a copy-never indication, a copy-no-more indication and a copy-once indication are provided with the material. Although shown as occurring sequentially, in practice there is no necessary order to such detections and preferably such detections are performed at substantially the same time.

If the copy-never indication is detected in 604, then jumping to 607, the preprocessing unit 110 does not allow copying of the material. It effectively does this by not transmitting the material to the recording unit 120. Likewise, if the copy-no-more indication is detected in 605, then the preprocessing unit 110 again jumps to 607, and does not allow copying of the material. If a copy-once indication is not detected in 606 as well as the copy-never and copy-no-more indications not being detected, then the preprocessing unit 110 does allow copying of the material. It effectively does this in 610 by transmitting the material to the recording unit 120.

On the other hand, if a copy-once indication is detected in 606, then in 608, the preprocessing unit 110 tries to establish a secure channel with the recording unit 120. If it is unable to establish the secure channel, then it jumps to 607, and does not allow copying of the material. If it is able to establish the secure channel, then in 609, the preprocessing unit 110 remarks the received material with a copy-no-more indication, encrypts the remarked material, and transmits it to the recording unit 120 via the encrypted/secure channel that it has established. After transmission of the material, the encrypted/secure channel is disabled.

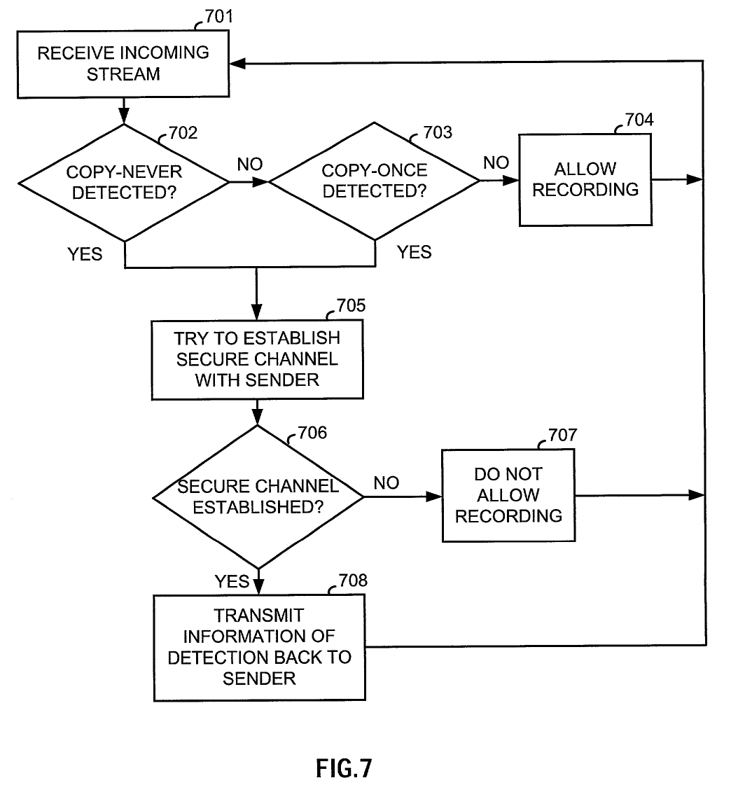

FIG. 7 illustrates, as an example, a flow chart of a method implemented in the recording unit 120 for providing protected copying of material that corresponds to the truth table described in reference to FIG. 4. In 701, the recording unit 120 receives a stream of material from the preprocessing unit 110 or other sender of the material. In 702 and 703, the recording unit 120 respectively detects whether a copy-never indication and a copy-once indication are provided with the material. Although shown as occurring sequentially, in practice there is no necessary order to such detections and preferably such detections are performed at substantially the same time.

If neither the copy-never indication nor the copy-once indication is detected, then in 704, the recording unit 120 allows the received material to be recorded. On the other hand, if either the copy-never indication or the copy-once indication is detected, then in 705, the recording unit 120 tries to establish a secure channel with the preprocessing unit 110 or other sender of the material. In 706, if the secure channel is established, then in 708, the recording unit 120 transmits information of the detected indication back to the preprocessing unit 110 or other sender of the material. On the other hand, if the secure channel is not established, the in 707, the recording unit 120 does not allow recording or copying of the received material.

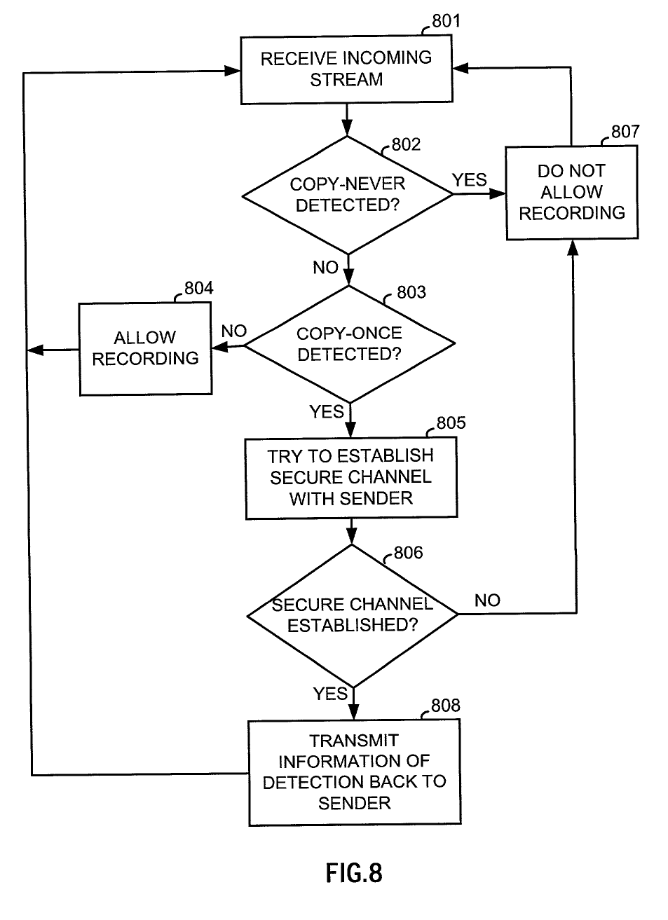

FIG. 8 illustrates, as an example, a flow chart of an alternative method that may be implemented in the recording unit 120 that corresponds to the truth table described in reference to FIG. 5. In 801, the recording unit 120 receives a stream of material from the preprocessing unit 110 or other sender of the material. In 802, if a copy-never indication is detected in the received material, then in 807, the recording unit 120 does not allow recording or copying of the received material. In 803, if neither the copy-never indication nor the copy-once indication is detected in the received material, then in 804, the recording unit 120 allows the received material to be recorded.

If the copy-once indication is detected, however, then in 805, the recording unit 120 tries to establish a secure channel with the preprocessing unit 110 or other sender of the material. In 806, if the secure channel is established, then in 808, the recording unit 120 transmits information of the detected indication back to the preprocessing unit 110 or other sender of the material. If the secure channel is not established, then the recording unit 120 jumps back to 807 so that the recording unit 120 does not allow recording or copying of the received material.

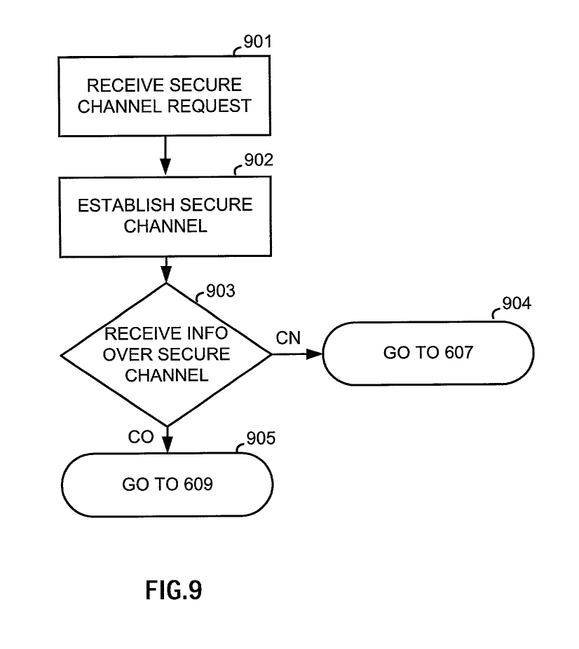

FIG. 9 illustrates, as an example, a flow chart of a method implemented in the preprocessing unit 110 for providing back-up detection of primary watermark detection that corresponds to the truth table of FIG. 3 and the corresponding methods described in reference to FIGS. 6 and 7. In 901, the preprocessing unit 110 receives a secure channel request from the recording unit 120. Such a request may occur at any time during transmission of material from the preprocessing unit 110 to the recording unit 120 under 610 of FIG. 6. In 902, the preprocessing unit 110 cooperates to establish the secure channel with the recording unit 120, and in 903, receives information of a copy-never or copy-once detection from the recording unit 120. If information of a copy-never indication is received, then in 904, the preprocessing unit 110 jumps back to 607 of FIG. 6, and stops transmitting the material to the recording unit 120. On the other hand, if information of a copy-once indication is received, then the preprocessing unit 110 jumps back to 609 of FIG. 6 to perform its copy-once functionality.

The flow chart of FIG. 9 may be modified to illustrate an alternative method that may be implemented in the preprocessing unit 110 for providing back-up detection of primary watermark detection that corresponds to the truth table of FIG. 4 and the corresponding methods described in reference to FIGS. 6 and 8. In that case, 904 would simply be removed since information of the copy-never indication is not sent back from the recording unit 120 to the preprocessing unit 110. The remaining parts of the flow chart would then operate in the same manner as described in reference to FIG. 9.

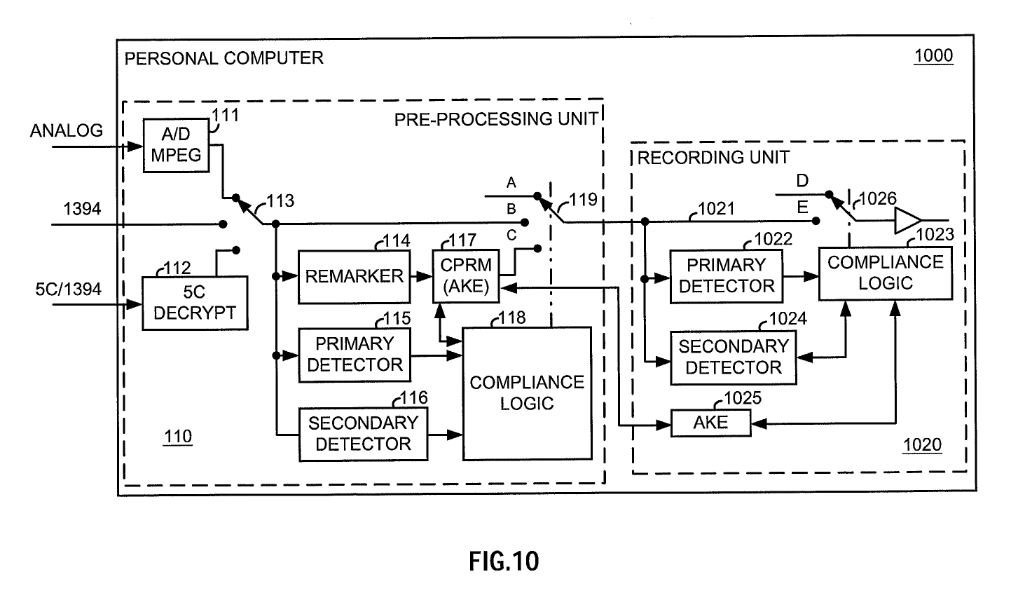

FIG. 10 illustrates, as an example, a block diagram of an alternative system implemented in a personal computer 1000 for providing protected copying of proprietary material. While the system described in reference to FIG. 1 only shows the primary detector in the recording unit, there may be situations where there are advantages and no particular disadvantages to having both the secondary and the primary detectors in the recording unit. In particular, if the secondary mark can be detected at minimal additional cost, even though the remarker may add additional cost, then adding a secondary detector to the recording unit may provide advantage. In some situations where a primary watermark has been weakened by various processing, then the secondary mark may be able to take over for the primary mark and thus there may be advantages from a system standpoint in performing both primary and secondary detection in the recording unit.

Accordingly, the alternative system includes the preprocessing unit 110 and a modified recording unit 1020. In this system, a secondary detector 1024 has been added to the recording unit 1020 to detect a copy-no-more indication included in material received by the recording unit 1020 for recording or copying. A primary detector 1022, AKE unit 1025, switch D-E 1026, and compliance logic 1023 are also included in the recording unit 1020. The primary detector 1022, AKE unit 1025, switch D-E 1026 operate substantially in the same manner as their counterparts in the recording unit 120 of FIG. 1. The compliance logic 1023 is a modified version of the compliance logic 123 of the recording unit 120 in FIG. 1, which accommodates the addition of the secondary detector 1024.

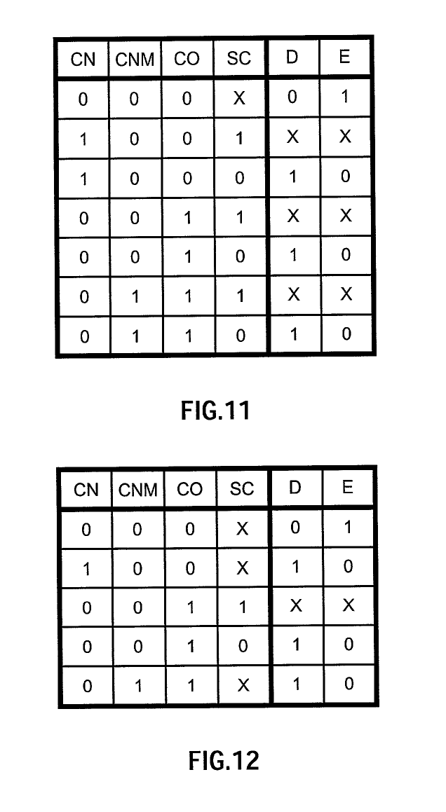

FIG. 11 illustrates, as an example, a truth table for the compliance logic 1023 as implemented in the recording unit 1020. Starting with the simple case where no watermarks are detected, the compliance logic 1023 in this situation causes the switch D-E 1026 to be placed in the E position so that the material can be recorded or copied. If either a CN, CNM or CO watermark is detected, however, then the compliance logic 1023 causes the AKE unit 1025 to try to establish a secure channel with the preprocessing unit 110. If a secure channel (“SC”) is established, then the compliance logic 1023 causes information of the watermark detection to be passed back to the recording unit 110, and leaves switch D-E 125 alone for the time being. The preprocessing unit 110 then uses the watermark information as though it had detected the same watermark(s) as the recording unit 1020. On the other hand, if the secure channel cannot be established, then the compliance logic 1023 causes the switch D-E 1026 to be placed in the D position so that the material cannot be recorded or copied.

FIG. 12 illustrates, as an example, a truth table for alternative compliance logic that may be implemented in the recording unit 1020. In this implementation, information of a CN or CNM watermark detection is not transmitted back to the preprocessing unit 110. Only information of a CO watermark detection is transmitted back to the preprocessing unit 110. Accordingly, when the CN or CNM watermark is detected in this implementation, the compliance logic causes the switch D-E 1026 to be placed in the D position so that the material cannot be recorded or copied. If the CO watermark is detected, however, then the compliance logic causes the AKE unit 1025 to try to establish a secure channel with the preprocessing unit 110. If a secure channel (“SC”) is established, then the compliance logic causes information of the CO watermark detection to be passed back to the recording unit 110, and leaves switch D-E 1026 alone. The preprocessing unit 110 then uses that information as though it had detected the CO watermark that was detected instead by the recording unit 1020. On the other hand, if the secure channel cannot be established, then the compliance logic causes the switch D-E 1026 to be placed in the D position so that the material cannot be recorded or copied.

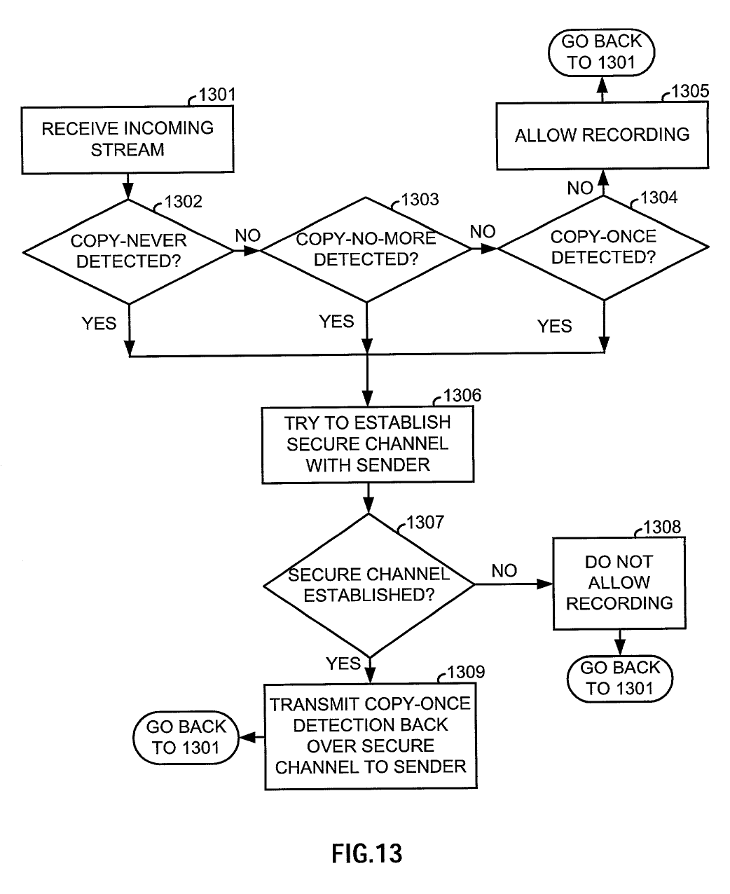

FIG. 13 illustrates, as an example, a flow chart of a method implemented in the recording unit 1020 that includes both primary 1022 and secondary 1024 detectors for providing protected copying of material that corresponds to the truth table described in reference to FIG. 11. In 1301, the recording unit 1020 receives a stream of material from the preprocessing unit 110 or other sender of the material. In 1302, 1303 and 1304, the recording unit 1020 respectively detects whether a copy-never indication, a copy-no-more indication and a copy-once indication are provided with the material. Although shown as occurring sequentially, in practice there is no necessary order to such detections and preferably such detections are performed at substantially the same time.

If none of the copy-never indication, the copy-no-more indication and the copy-once indication are detected, then in 1305, the recording unit 1020 allows the received material to be recorded. On the other hand, any one of the copy-never indication, the copy-no-more indication or the copy-once indication is detected, then in 1306, the recording unit 1020 tries to establish a secure channel with the preprocessing unit 110 or other sender of the material. In 1307, if the secure channel is established, then in 1309, the recording unit 1020 transmits information of the detected indication back to the preprocessing unit 110 or other sender of the material, and disables the secure channel after completion of such transmission. On the other hand, if the secure channel is not established, the in 1308, the recording unit 1020 does not allow recording or copying of the received material.

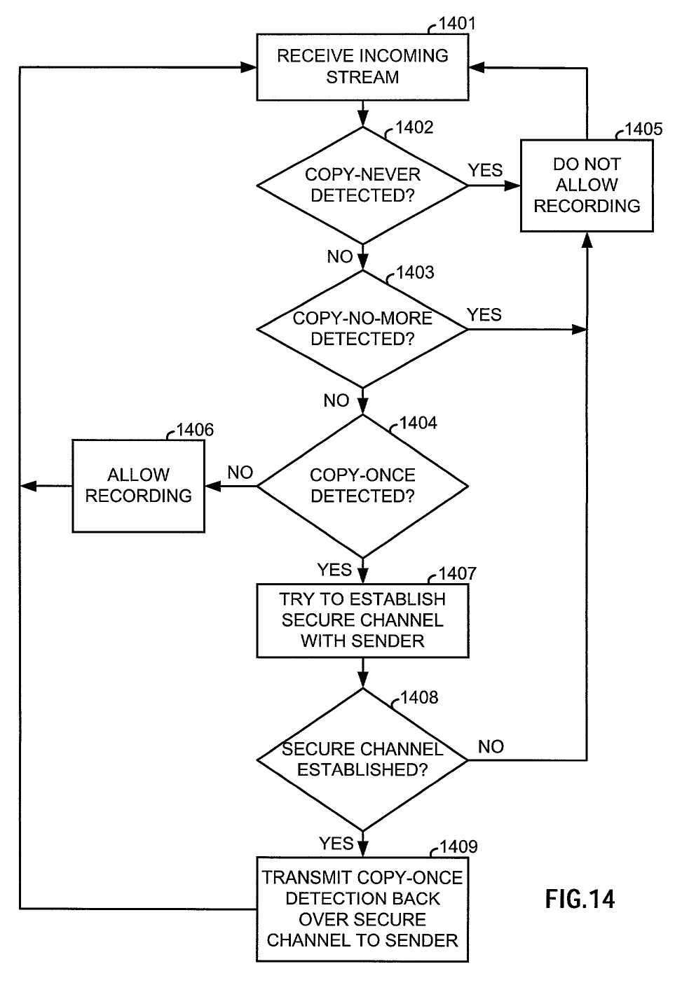

FIG. 14 illustrates, as an example, a flow chart of an alternative method that may be implemented in the recording unit 1020 that corresponds to the truth table described in reference to FIG. 12. In 1401, the recording unit 1020 receives a stream of material from the preprocessing unit 110 or other sender of the material. In 1402, if a copy-never indication is detected in the received material, then in 1405, the recording unit 1020 does not allow recording or copying of the received material. Likewise, in 1403, if a copy-no-more indication is detected in the received material, then the recording unit jumps back to 1405 so as to also not to allow recording or copying of the received material.

In 1404, if a copy-once indication is also not detected, then in 1406, the recording unit 1020 allows the received material to be recorded since it has not detected any of the copy-never, copy-no-more or copy-once indications in the received material. On the other hand, in 1404, if the copy-once is detected, however, then in 1407, the recording unit 1020 tries to establish a secure channel with the preprocessing unit 110 or other sender of the material. In 1408, if the secure channel is established, then in 1409, the recording unit 1020 transmits information of the detected copy-once indication back to the preprocessing unit 110 or other sender of the material. If the secure channel is not established, then the recording unit 1020 jumps back to 1405 so that the recording unit 1020 does not allow recording or copying of the received material.

Although the various aspects of the invention have been described with respect to preferred embodiments, it will be understood that the invention is entitled to full protection within the full scope of the appended claims.

We claim:

1. A system for providing protected copying of material, comprising:
a preprocessing unit having an output and capable of providing copy-once functionality on a material before providing said material on said output; and
a recording unit coupled to said preprocessing unit output, and capable of searching for a copy-never indication in said material provided on said preprocessing unit output and copying said material unless said copy-never indication is found, but lacking capability to remark said material with a copy-no-more indication.

2. The system according to claim 1, wherein said copy-never indication comprises a copy-never watermark embedded in said material.

3. The system according to claim 1, wherein said copy-once functionality includes searching for a copy-once indication and a copy-no-more indication in said material, not providing said material on said preprocessing unit output if said copy-no-more indication is found, and remarking said material with said copy-no-more indication before providing said material on said preprocessing unit output if said copy-once indication is found and said copy-no-more indication is not found.

4. The system according to claim 3, wherein said copy-once indication comprises a copy-once watermark embedded in said material.

5. The system according to claim 3, wherein said copy-no-more indication comprises a copy-no-more watermark embedded in said material.

6. The system according to claim 3, wherein said preprocessing unit and said recording unit are further capable of establishing a secure channel between themselves to pass said material from said preprocessing unit to said recording unit if said preprocessing unit finds said copy-once indication and does not find said copy-no-more indication in said material.

7. The system according to claim 6, wherein said secure channel is established by performing an authentication and key exchange process between said preprocessing unit and said recording unit.

8. The system according to claim 7, wherein said authentication and key exchange process is a Diffie-Hellman process.

9. The system according to claim 1, wherein said recording unit is further capable of searching for a copy-once indication in said material, and copying said received material only if said copy-never indication and said copy-once indication are not found.

10. The system according to claim 9, wherein said recording unit is further capable of communicating information of finding said copy-once indication back to said preprocessing unit if a secure channel is established between said recording unit and said preprocessing unit.

11. The system according to claim 10, wherein said secure channel is established between said recording unit and said preprocessing unit before said copy-once indication is found in said material by said recording unit.

12. The system according to claim 10, wherein said secure channel is established between said recording unit and said preprocessing unit after said copy-once indication is found in said material by said recording unit.

13. The system according to claim 10, wherein said preprocessing unit is further capable of responding to said information of finding said copy-once indication received from said recording unit as though said preprocessing unit had itself found said copy-once indication.

14. The system according to claim 1, wherein said material comprises audio-visual content.

15. The system according to claim 1, wherein said preprocessing unit is included on an expansion board of a personal computer.

16. The system according to claim 15, wherein said expansion board is a video capture board.

17. The system according to claim 15, wherein said expansion board is a network board.

18. The system according to claim 1, wherein said preprocessing unit includes software running on a processor.

19. The system according to claim 1, wherein said preprocessing unit is included in a network appliance coupled to said recording unit.

20. The system according to claim 1, wherein said preprocessing unit is included in a set-top box coupled to said recording unit.

21. The system according to claim 1, wherein said recording unit is a DVD recordable drive.

22. A method implemented in a recording unit for providing protected copying of material, comprising:
detecting if a copy-never or copy-once indication is provided with a material;
if said copy-never indication is detected, then not allowing copying of said material;
if neither said copy-never nor said copy-once indication is detected, then allowing copying of said material; and
if said copy-once indication is detected, then transmitting information of said detection of said copy-once indication back to a sender of said material provided a secure channel is established with said sender, otherwise not allowing copying of said material.

23. The method according to claim 22, wherein said material comprises audio-visual content.

24. The method according to claim 22, wherein said copy-never indication comprises a copy-never watermark embedded in said material.

25. The method according to claim 22, wherein said copy-once indication comprises a copy-once watermark embedded in said material.

26. The method according to claim 22, wherein said recording unit is a DVD recordable drive.

27. The method according to claim 22, further comprising receiving said material from an expansion board included in a personal computer.

28. The method according to claim 27, wherein said expansion board is a video capture board coupled to said recording unit.

29. The method according to claim 27, wherein said expansion board is a network board coupled to said recording unit.

30. The method according to claim 22, further comprising receiving said material from a network appliance coupled to said recording unit.

31. The method according to claim 22, further comprising receiving said material from a set-top box coupled to said recording unit.

32. The method according to claim 22, wherein said transmitting information of said detection of said copy-once indication back to a sender of said material provided a secure channel is established with said sender, otherwise not allowing copying of said material, comprises:
if said copy-never indication is not detected and said copy-once indication is detected, then
if a secure channel is already established with said sender of said material, then transmitting information of said detection of said copy-once indication back to said sender of said material, and
if said secure channel is not already established with said sender of said material, then not allowing copying of said material.

33. The method according to claim 22, wherein said transmitting information of said detection of said copy-once indication back to a sender of said material provided a secure channel is established with said sender, otherwise not allowing copying of said material, comprises:
if said copy-never indication is not detected and said copy-once indication is detected, then establishing a secure channel with said sender of said material;
if said secure channel cannot be established, then not allowing copying of said material; and
if said secure channel is established, then transmitting information of said detection of said copy-once indication back to said sender of said material.

34. The method according to claim 33, wherein said secure channel is established by performing an authentication and key exchange process between said sender of said material and said recording unit.

35. The method according to claim 34, wherein said authentication and key exchange process is a Diffie-Hellman process.

36. The method according to claim 22, further comprising:
detecting if a copy-no-more indication is provided with said material; and
if said copy-no-more indication is detected, then not allowing copying of said material.

37. The method according to claim 36, further comprising:
if said copy-never indication is not detected, said copy-once indication is detected, and said copy-no-more indication is not detected, then
if a secure channel is already established with said sender of said material, then transmitting information of said detection of said copy-once indication back to said sender of said material, and
if said secure channel is not already established with said sender of said material, then not allowing copying of said material.

38. The method according to claim 36, further comprising:
if said copy-never indication is not detected, said copy once indication is detected, and said copy-no-more indication is not detected, then establishing a secure channel with a sender of said material;
if said secure channel cannot be established, then not allowing copying of said material; and
if said secure channel is established, then transmitting information of said detection of said copy-once indication back to said sender of said material.

39. The method according to claim 38, wherein said secure channel is established by performing an authentication and key exchange process between said sender of said material and said recording unit.

40. The method according to claim 39, wherein said authentication and key exchange process is a Diffie-Hellman process.

41. The method according to claim 37, wherein said copy-no-more indication comprises a copy-no-more watermark embedded in said material.

42. A recording unit for providing protected copying of material, comprising:
an input channel receiving a material for copying;
a primary detector coupled to said input channel to detect if a copy-never indication and a copy-once indication are provided with said material; and
compliance logic coupled to said primary detector and configured such that if said copy-never indication is detected, then preventing said material from being copied, and if neither said copy-never nor said copy-once indication is detected, then allowing said material to be copied.

43. The recording unit according to claim 42, wherein said material comprises audio-visual content.

44. The recording unit according to claim 42, wherein said copy-never indication comprises a copy-never watermark embedded in said material.

45. The recording unit according to claim 42, wherein said copy-once indication comprises a copy-once watermark embedded in said material.

46. The recording unit according to claim 42, wherein said recording unit is a DVD recordable drive.

47. The recording unit according to claim 42, wherein said material is received from an expansion board included in a personal computer.

48. The recording unit according to claim 47, wherein said expansion board is a video capture board coupled to said recording unit.

49. The recording unit according to claim 47, wherein said expansion board is a network board coupled to said recording unit.

50. The recording unit according to claim 42, wherein said material is received from a network appliance coupled to said recording unit.

51. The recording unit according to claim 42, wherein said material is received from a set-top box coupled to said recording unit.

52. The recording unit according to claim 42, further comprising secure channel logic configured such that:
if said copy-never indication is not detected and said copy-once indication is detected, then
if a secure channel has already been established with a sender of said material, then causing information of said detection of said copy-once indication to be transmitted back to said sender of said material, and
if a secure channel has not already been established with said sender of said material, then communicating with said compliance logic so as to not allow copying of said material.

53. The recording unit according to claim 42, further comprising secure channel logic configured such that:
if said copy-never indication is not detected and said copy-once indication is detected, then establishing a secure channel with a sender of said material;
if said secure channel cannot be established, then communicating with said compliance logic so as to not allow copying of said material;
if said secure channel is established, then causing information of said detection of said copy-once indication to be transmitted back to said sender of said material.

54. The recording unit according to claim 53, wherein said secure channel is established by performing an authentication and key exchange process between said sender of said material and said recording unit.

55. The recording unit according to claim 54, wherein said authentication and key exchange process is a Diffie-Hellman process.

56. The recording unit according to claim 42, further comprising a secondary detector coupled to said input channel to detect if a copy-no-more indication is provided with said material, and said compliance logic is further coupled to said secondary detector and configured such that if said copy-no-more indication is detected, then not allowing copying of said material.

57. The recording unit according to claim 56, wherein said compliance logic is further configured such that:
if said copy-never indication is not detected, said copy-once indication is detected, and said copy-no-more indication is not detected, then causing said secure channel logic to determine if a secure channel can be established with a sender of said material;
if said secure channel cannot be established, then not allowing copying of said material; and
if said secure channel can be established, then transmitting information of detection of said copy-once indication back to said sender of said material, and disabling said secure channel after such transmission.

58. The recording unit according to claim 57, wherein said secure channel is established by performing an authentication and key exchange process between said sender of said material and said recording unit.

59. The recording unit according to claim 58, wherein said authentication and key exchange process is a Diffie-Hellman process.

60. The recording unit according to claim 56, wherein said copy-no-more indication comprises a copy-no-more watermark embedded in said material.

61. The recording unit according to claim 42, wherein said compliance logic comprises a processor.

62. The recording unit according to claim 42, wherein said compliance logic comprises a state machine.

63. The recording unit according to claim 42, wherein said compliance logic comprises at least one logic circuit.

64. A system for providing protected copying of material, comprising:
a preprocessing unit having at least one input channel for receiving material and an output channel for providing an output, wherein said material is provided as said output if neither a copy-never indication nor a copy-once indication is detected as being provided with said material, said material is not provided as said output if either said copy-never indication is detected as being provided or said copy-once indication and a copy-no-more indication are both detected as being provided with said material, and an encrypted version of said material including said copy-no-more indication is provided as said output and said output channel is configured to be a secure channel if said copy-once indication is detected and said copy-no-more indication is not detected prior to said inclusion with said material; and
a recording unit coupled to said output channel of said preprocessing unit and including a primary detector to detect if a copy-never indication and a copy-once indication are provided with said preprocessing unit's output; and compliance logic coupled to said primary detector and configured such that if said copy-never indication is detected, then not allowing said preprocessing unit's output to be copied, and if neither said copy-never nor said copy-once indication is detected, then allowing said preprocessing unit's output to be copied.

66. The system according to claim 64, wherein said compliance logic is further configured such that if said copy-once indication is detected, then establishing a secure channel with said preprocessing unit and passing information of said detection of said copy-once indication back to said preprocessing unit over said secure channel.

67. The system according to claim 66, wherein said preprocessing unit receives said information of said detection of said copy-once indication passed back by said recording unit, and provides said encrypted version of said material including said copy-no-more indication as said output over said secure channel.

68. The system according to claim 64, wherein said recording unit further includes a secondary detector to detect if a copy-no-more indication is provided with said preprocessing unit output, and said compliance logic is further configured such that if said copy-once indication is detected and said copy-no-more indication is not detected, then passing information of said detection of said copy-once indication back to said preprocessing unit over said secure channel if said secure channel has already been established.

69. The system according to claim 64, wherein said recording unit further includes a secondary detector to detect if a copy-no-more indication is provided with said preprocessing unit output, and said compliance logic is further configured such that if said copy-once indication is detected and said copy-no-more indication is not detected, then establishing a secure channel with said preprocessing unit and passing information of said detection of said copy-once indication back to said preprocessing unit over said secure channel.

70. The system according to claim 64, wherein said material comprises audio-visual content.

71. The system according to claim 64, wherein said copy-never indication comprises a copy-never watermark embedded in said material.

72. The system according to claim 64, wherein said copy-once indication comprises a copy-once watermark embedded in said material.

73. The system according to claim 64, wherein said copy-no-more indication comprises a copy-no-more watermark embedded in said material.

74. The system according to claim 64, wherein said preprocessing unit is an expansion board included in a personal computer.

75. The system according to claim 64, wherein said preprocessing unit is a network appliance coupled to said recording unit.

76. The system according to claim 64, wherein said preprocessing unit is a set-top box coupled to said recording unit.

77. The system according to claim 64, wherein said recording unit is a DVD recordable drive.

78. The system according to claim 64, wherein said secure channel is configured by performing an authentication and key exchange process between said preprocessing unit and said recording unit.

79. The system according to claim 64, wherein said compliance logic comprises a processor.

80. The system according to claim 64, wherein said compliance logic comprises a state machine.

81. The system according to claim 64, wherein said compliance logic comprises at least one circuit.
